(19) United States
(12) Patent Application Publication
(10) Pub. No.: US 2012/0137554 A1
(43) Pub. Date: Jun. 7, 2012

(54) ADVERTISING DISPLAY DEVICES AND CONSTITUENT STRUCTURES

(76) Inventor: Fabio Puello, Santo Domingo (DO)

(21) Appl. No.: 12/734,603

(22) PCT Filed: Oct. 28, 2008
(86) PCT No.: PCT/DO2008/000005

§ 371 Date: Aug. 6, 2010

(30) Foreign Application Priority Data
Nov. 16, 2007 (DO) P2007-0141

(51) Int. Cl. G09F 15/00

(52) U.S. Cl. 40/607.1

(57) ABSTRACT

The present invention relates to the field of advertising and especially with advertising displays and structures that allow assembling advertising devices which show information on two, three, four and more faces to providing full access to advertisement. These devices are characterized by having at least two columns profiles (1) formed by polygonal bases; at least one tank-type lower tubular link profile (2) that functions as a storage tank or reservoir of a liquid or sand to form a base that does not need to be anchored to the ground by means of mechanical fasteners; at least one upper tubular link (3); at least two corner bases (4); at least two upper corners (5); and at least one advertising display support frame (6).

The present invention relates to the advertising industry and specifically to devices and profiles advertising displays and structures for assembling advertising devices which provide information for two, three, four and more faces providing full access to the advertising message. These advertising devices may be placed in many different locations and in particular on public roads, malls, shops, galleries, trade fairs, sidewalks or any other desired location wherein the advertising is placed in order to be visible form different angles.

### DESCRIPTION OF PRIOR ART

It is widely known that there are multiple ways to project an advertising message. Among these, advertising billboards and towers have been one of the most frequently used over the years, especially when using medium and large advertising formats.

Generally, these advertising billboards and towers comprise a flat structure that supports the advertising device. Publicity is placed on one face in the case of billboards, what indicates that people should be placed in front of it to have visual access to the message, or at an angle in which the human eye can capture the displayed information. These aspects show the limitations this device has. In other cases billboards are fitted with a rotation mechanism (electric motor), allowing them to rotate 360 degrees, showing their main faces but this does not eliminate the problem which means, that it is not possible to place an advertisement on the side parts of these billboards. Moreover, advertising towers are generally composed by a base, a column or pole fixed to the floor that rises perpendicular to this, and an upper structure of two or more faces, in which advertising is placed. These towers have the disadvantage of being not aesthetically pleasing, their structures are hardly functional and are limited to open spaces or outdoors.

Technologies focused on solving the problems described above are known in the state of the art. Patent ES1061864U entitled: “Advertising Structure Support”, publication date Apr. 16, 2006 and being ANDUJAR PEDRO MARQUES the applicant; describes and claims an advertising structure, especially to be placed at roundabouts or squares. This device is characterized by having a triangular prism shape defined by vertical tubular elements anchored to the ground, and these elements are related by other perimeter elements. Each side has frames that are part of the structure. Flexible surfaces containing advertising messages are placed on the frames. While this device can display advertising messages on three sides, it is also true that being anchored or fix to the ground is the main difficult because it not only limits its movement capacity but also its possibilities of use. Also, exposing publicity is limited to only the three faces of the structure.

Patent JP2000162972 entitled: “ADVERTISING TOWER MADE OF CANVAS”, publication date Jun. 16, 2006 and being SUGAMOTO TENT KK the applicant; claims a four-sided advertising tower having fixed to it aluminum frames, from where replaceable panels of canvas are place. In this tower faces are square. This suggests that it is needed a square base in order to fix the faces to the base and form the structure. This indicates that the tower will need some fixing pieces somewhere in its structure to avoid maladjustment.

In general terms, the main problems present in current advertising structures and that are solved with the present invention are:

1—They are limited regarding the capacity to display the advertising message from different angles.

2—Many people make fixed structures.

3—Many people make flat supports having one or two areas in which the advertisement is placed.

4—They have specific areas of application resulting from their own structures and configurations.

5—Sometimes they required to be physically fixed to the ground.

### DESCRIPTION OF THE INVENTION

A primary objective of the present invention is to provide different patterns and structures to assemble disparate and variable advertising devices that can be widely used in shopping malls, fairs, airports, ports, parking, entertainment, streets, highways, streets, stadiums, buildings, hotels, among others.

A second objective of the present invention is to provide advertising space to make public goods and services indoor or outdoor, characterized by its easy assembly and disassembly.

A third objective of the present invention is to provide advertising devices that do not require to be fixed or physically bound to the ground and therefore, can be moved from place to another according to the requirements and demands.

A fourth objective is to provide advertising devices that require no fixing devices or anchors to be adjusted.

A fifth objective of the present invention is to provide an advertising device which, although not carrying an advertising message does not damage the visual environment in which it is placed.

A final objective of this invention is to provide a structure or advertising device of great balance and resistance to the winds.

For the purpose of assisting the interpretation of the invention described below, for illustration and not limiting its scope, the drawings of the invention are part of the present invention.

Figures:

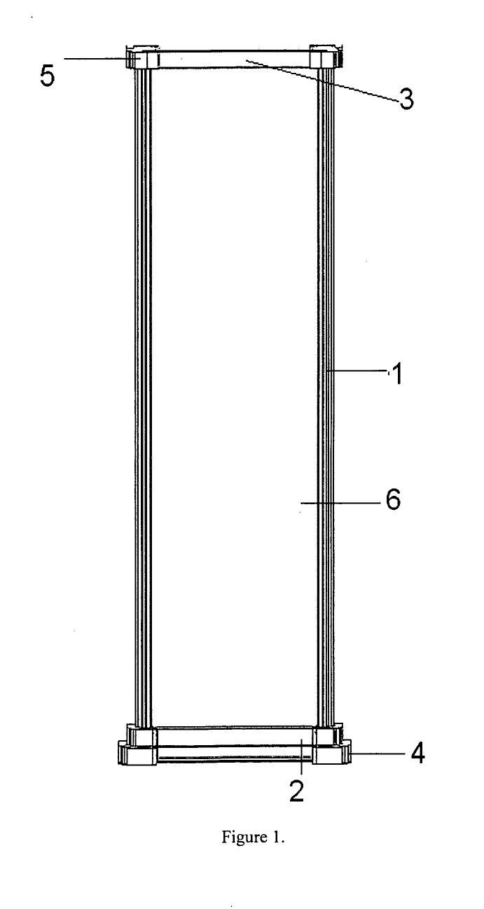

FIG. 1 shows a front view of the flat advertising tower.

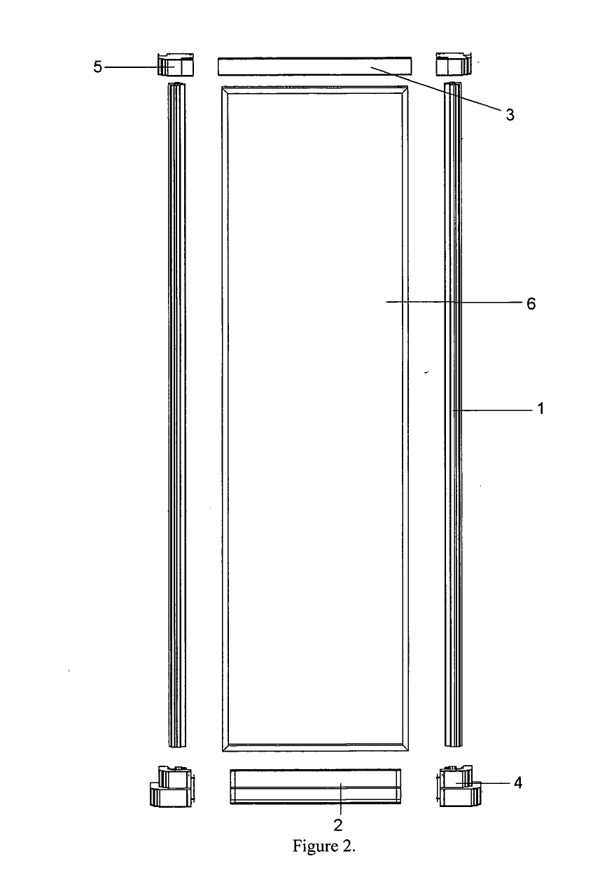

FIG. 2 illustrates an exploded view of the flat advertising tower showing all its component parts.

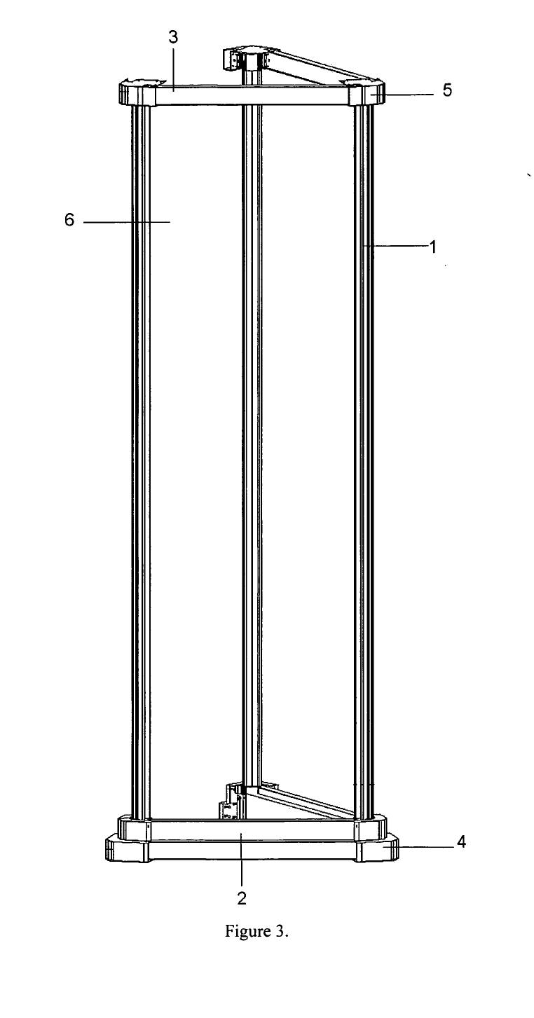

FIG. 3 shows a side view of the advertising tower in a “V” shape.

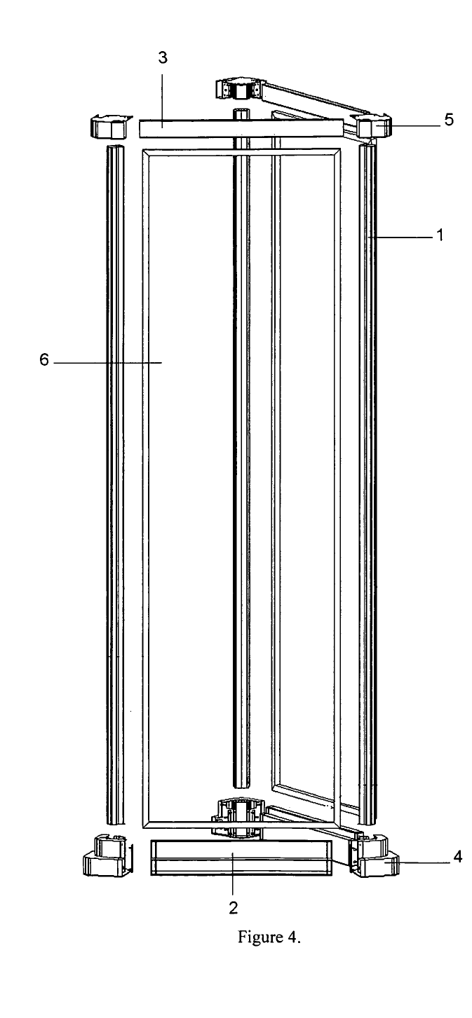

FIG. 4 illustrates an explosion side view of the advertising tower in a “V” shape showing all its component parts.

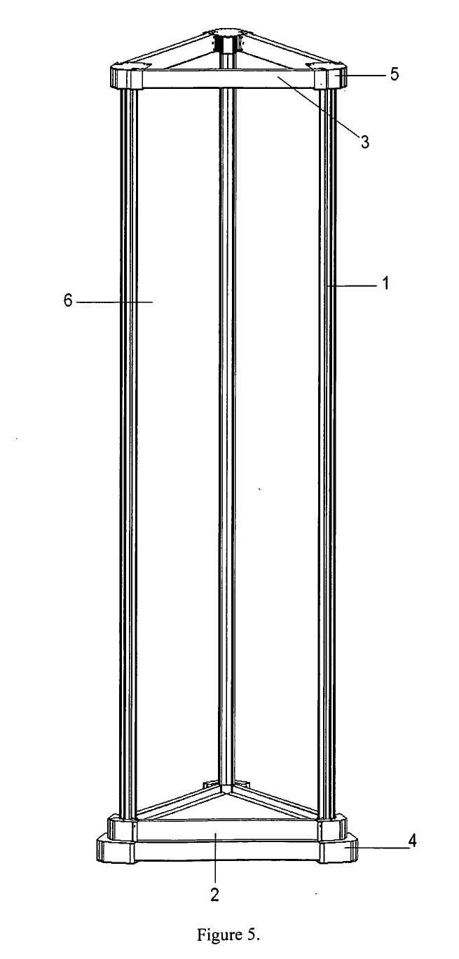

FIG. 5 shows a front view of the advertising tower triangular-shaped base prism.

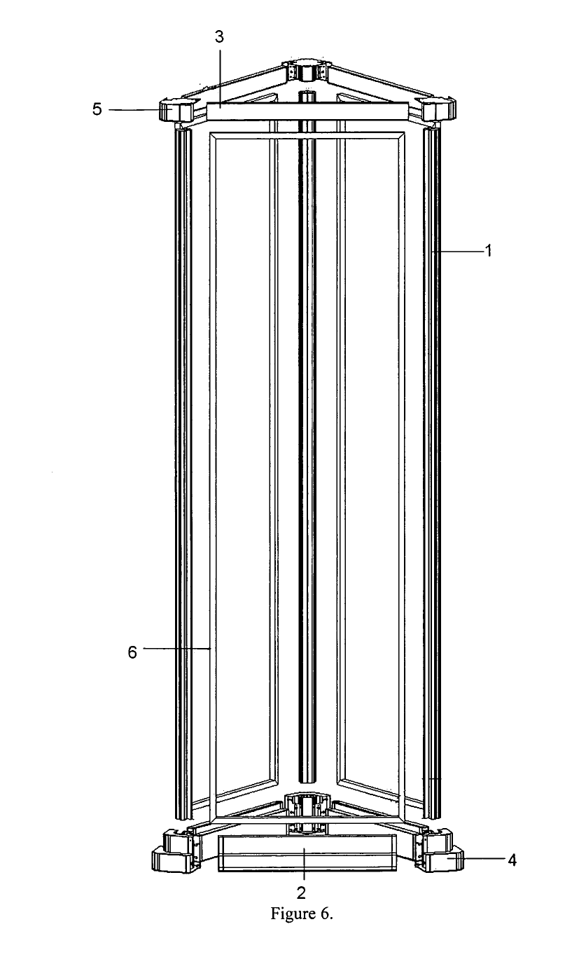

FIG. 6 illustrates a front view of the advertising tower having a triangular base showing all its component parts.

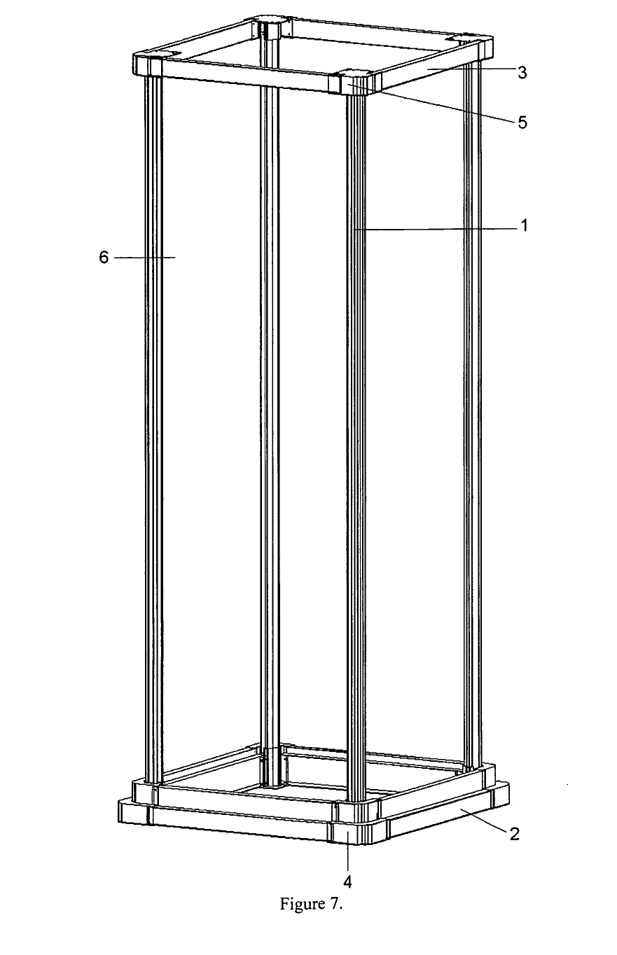

FIG. 7 shows a diagonal view of the advertising tower in the shape of a vertical rectangular cube.

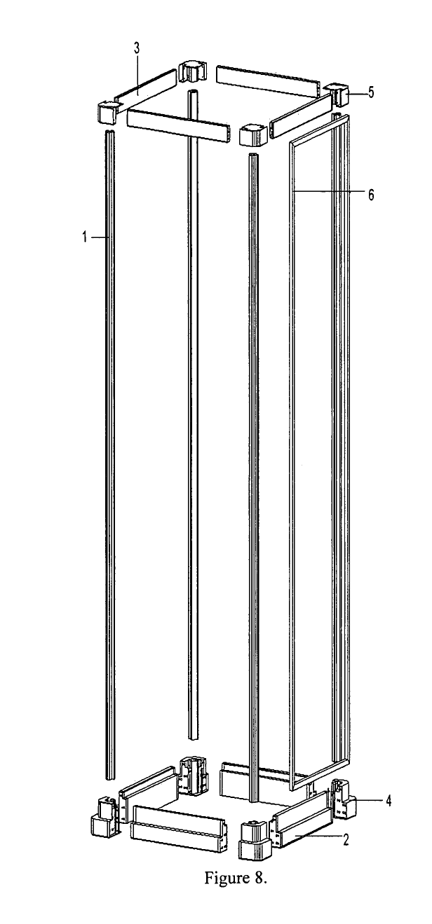

FIG. 8 illustrates a diagonal view of the advertising tower in the shape of vertical rectangular cube, showing all its component parts.

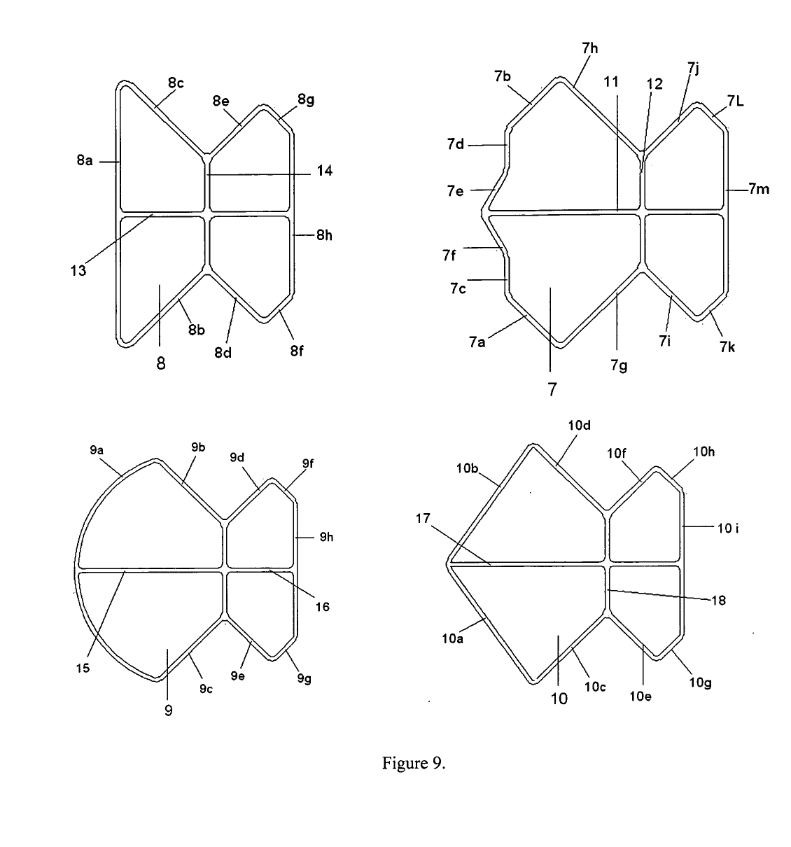

FIG. 9 is a upper view of four column profiles.

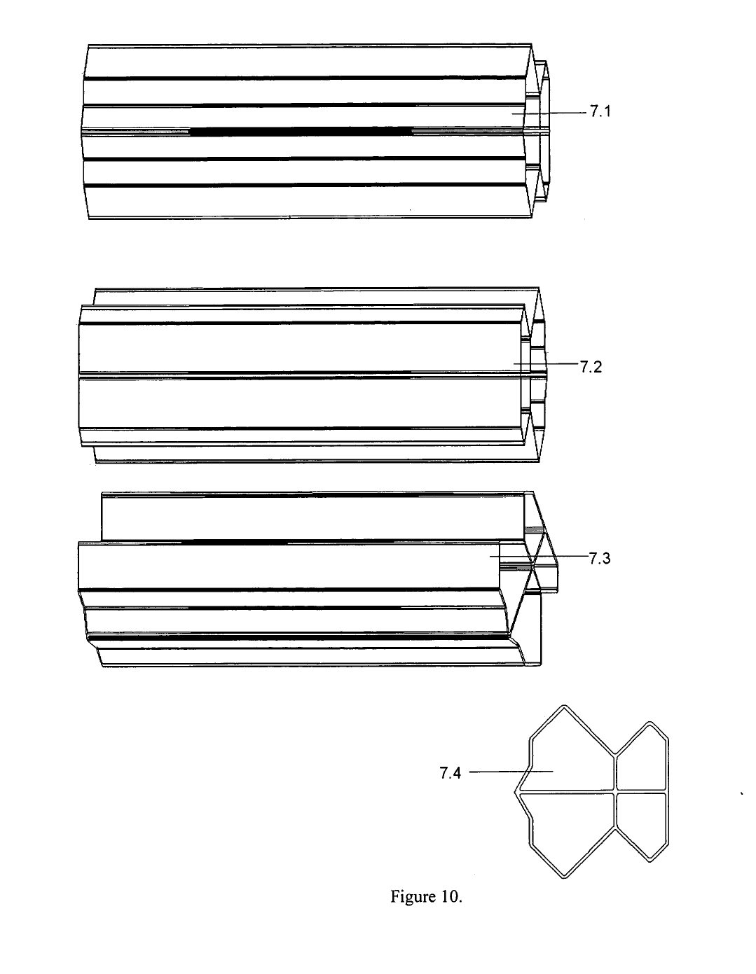

FIG. 10 shows a side view front, a rear side view, a upper view and diagonal view of the column profile of 13 sides.

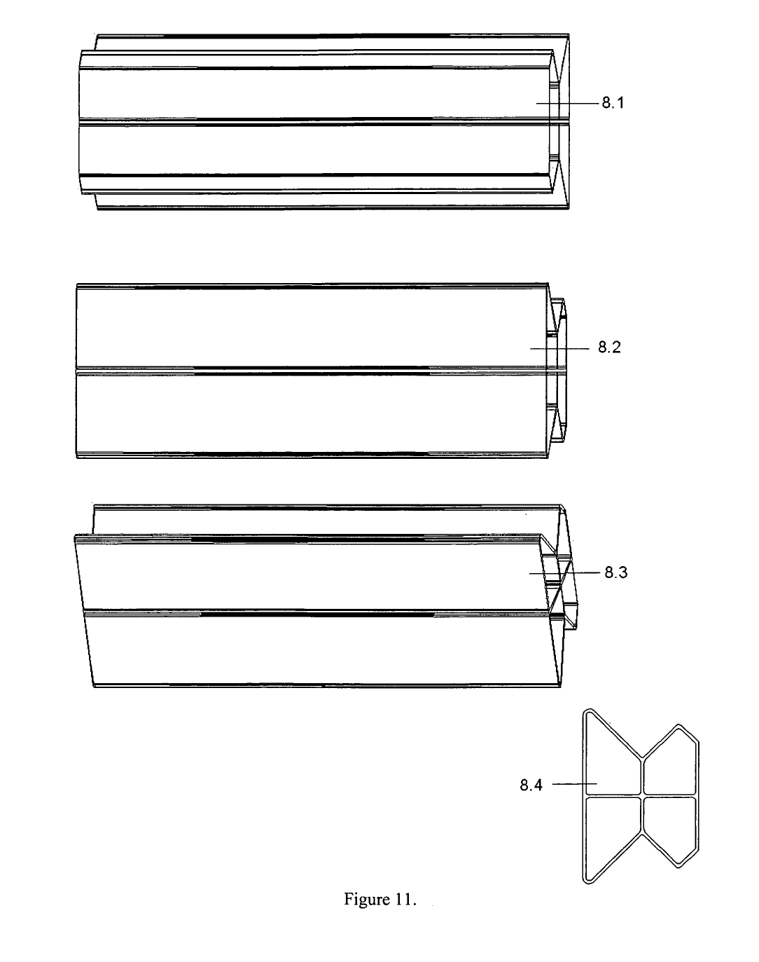

FIG. 11 shows a front side view, a rear side view, a diagonal view and a vertical upper view of the column profile of 8 sides.

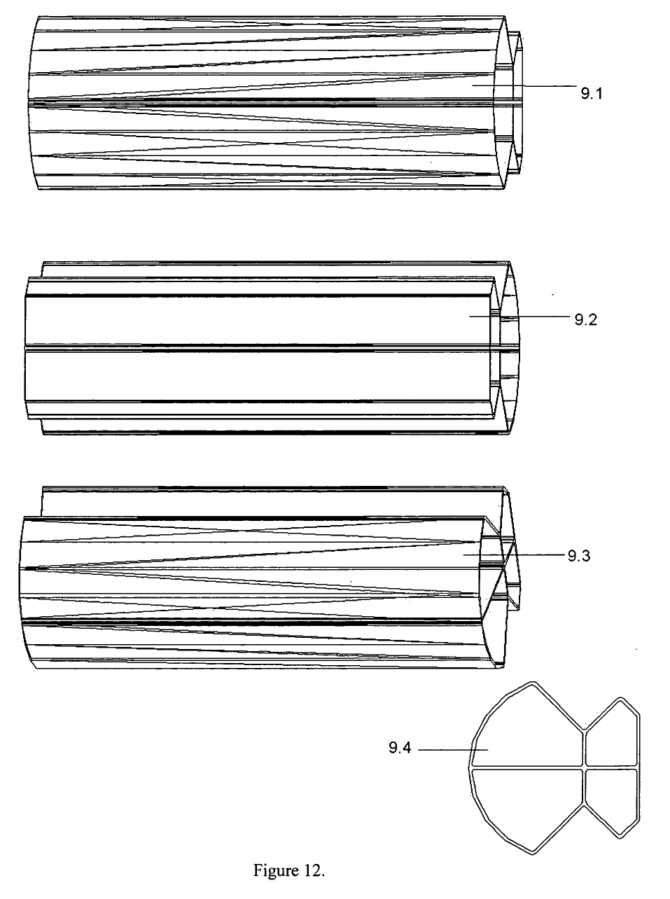

FIG. 12 shows a side front view, a rear side view, a diagonal view and a vertical upper view of the column profile of 8 sides where the biggest of them is curved.

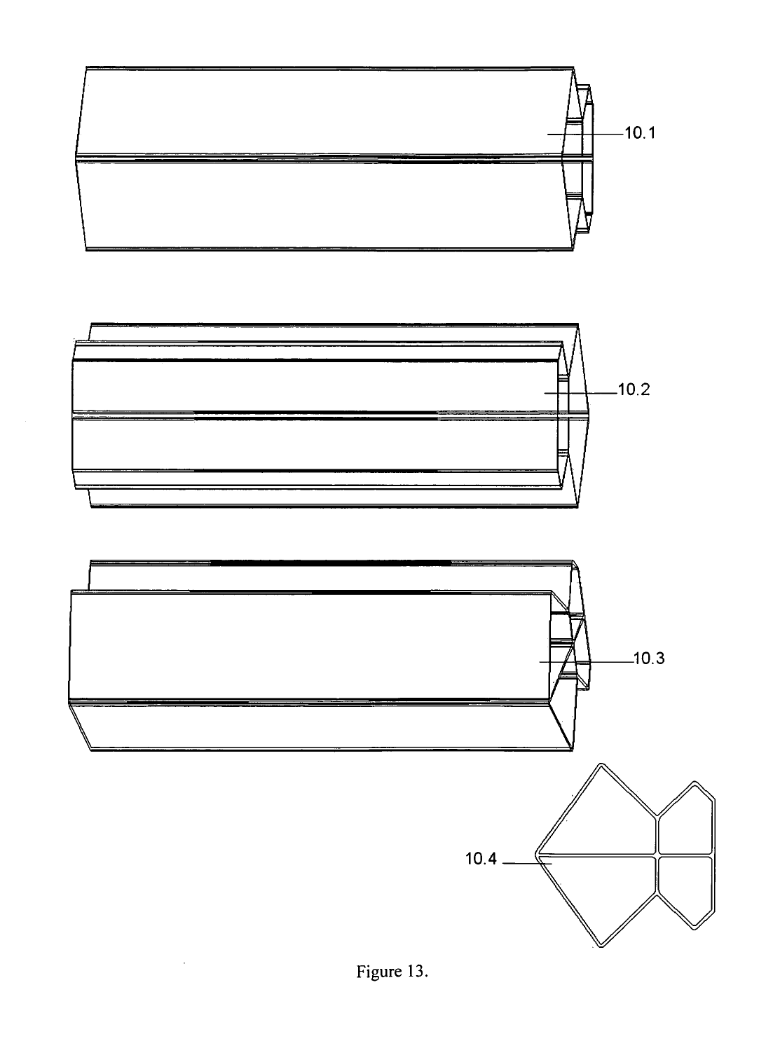

FIG. 13 shows a front side view, a rear side view, a diagonal view and a vertical upper view column profile of 9 sides.

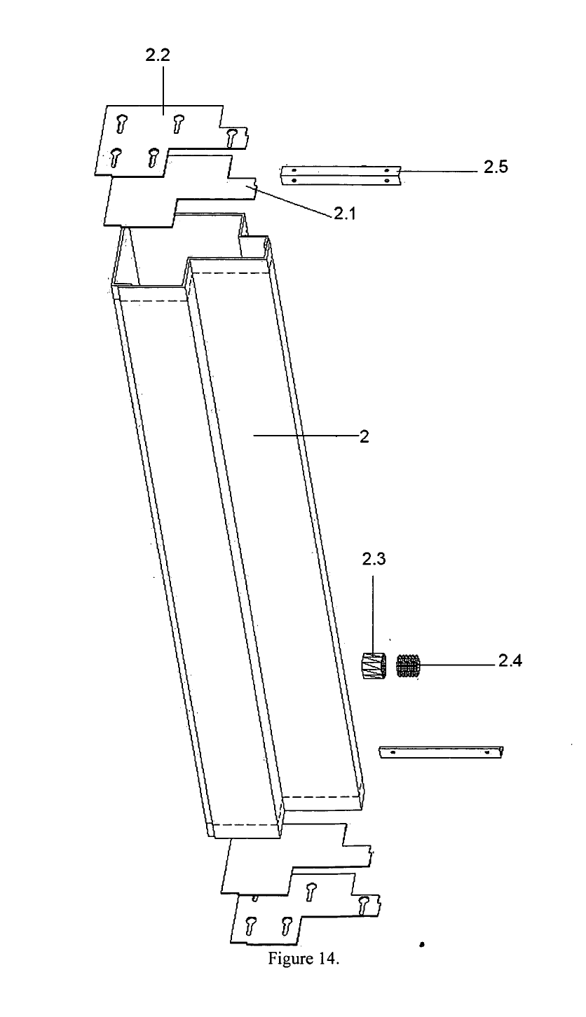

FIG. 14 shows a view of the lower tubular link where you can appreciate all its component parts.

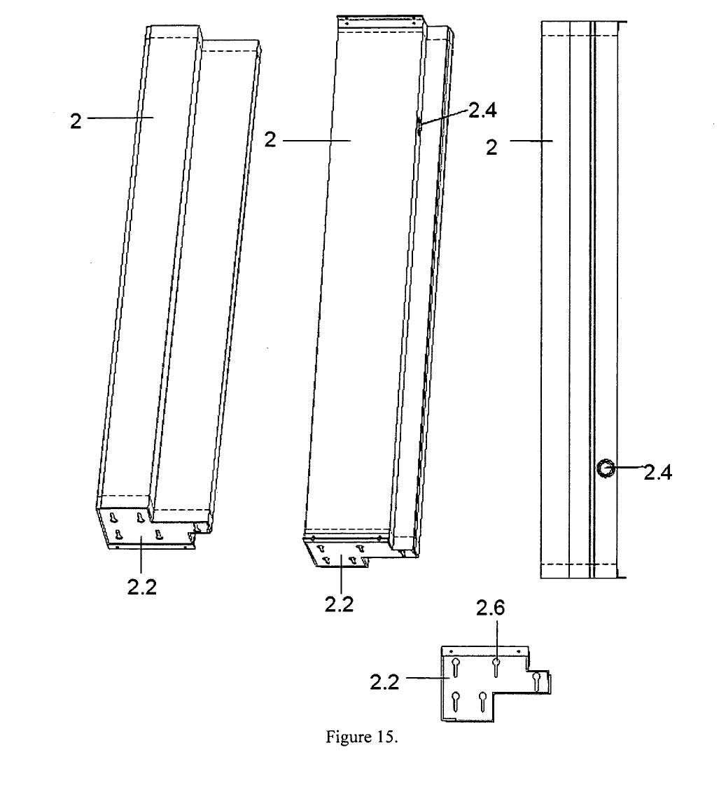

FIG. 15 shows two side views, a horizontal upper view and a vertical upper view of the lower tubular link.

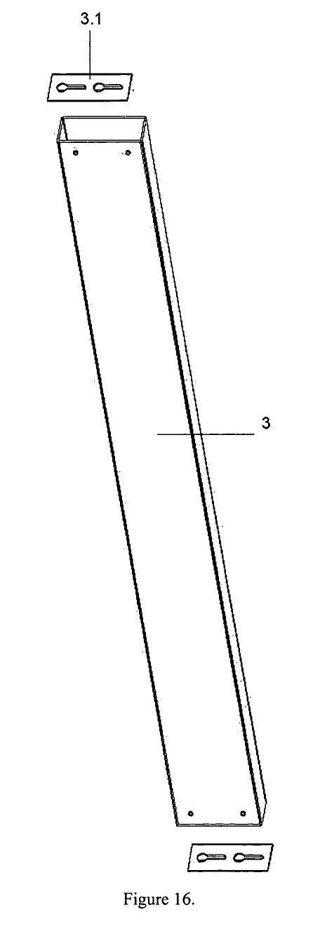

FIG. 16 illustrates a view of the upper tubular link showing all its component parts.

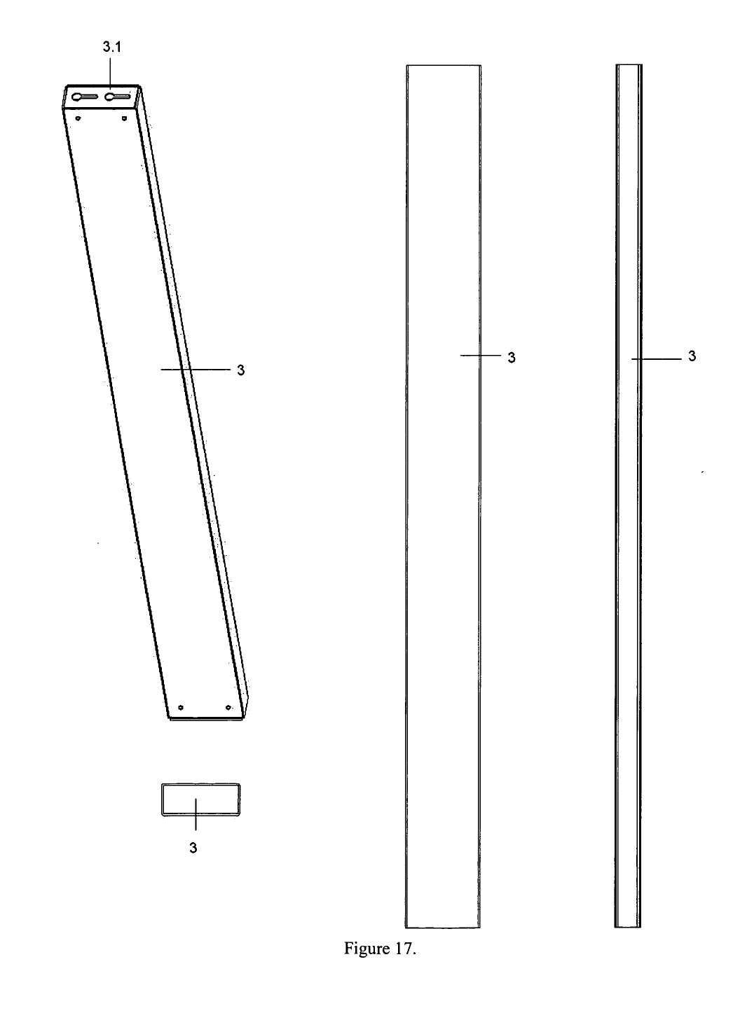

FIG. 17 shows a diagonal view, a side view, a horizontal upper view, and a vertical upper view of the tubular bond.

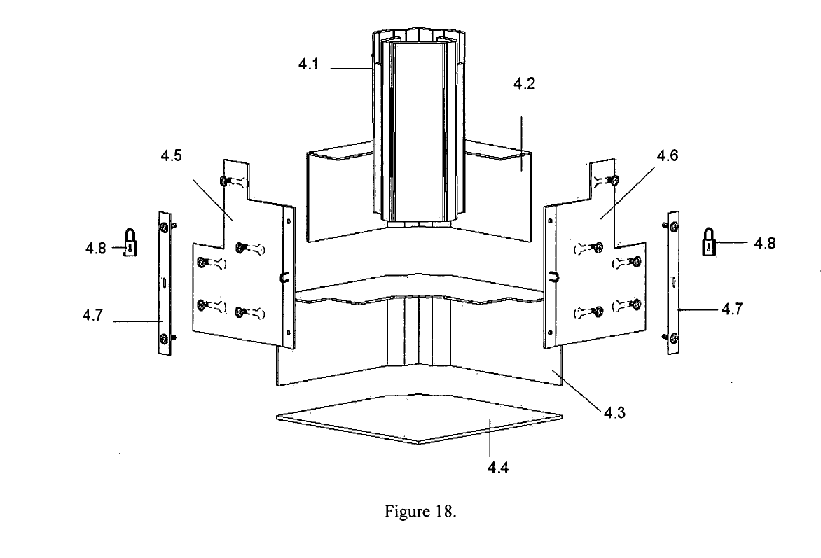

FIG. 18 illustrates a view of the lower upper corner base showing all its component parts.

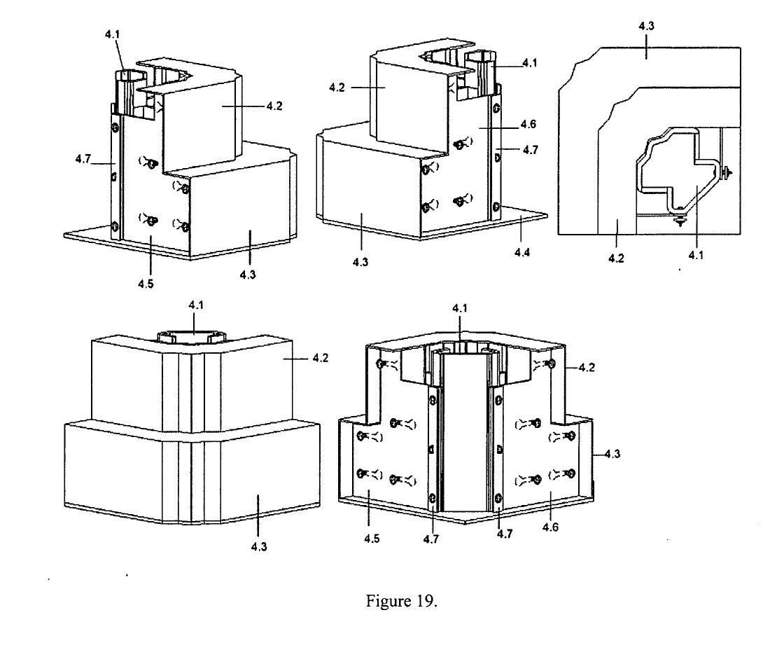

FIG. 19 shows a front view, a rear view, a right side view, a left side view and a upper view of the lower base corner.

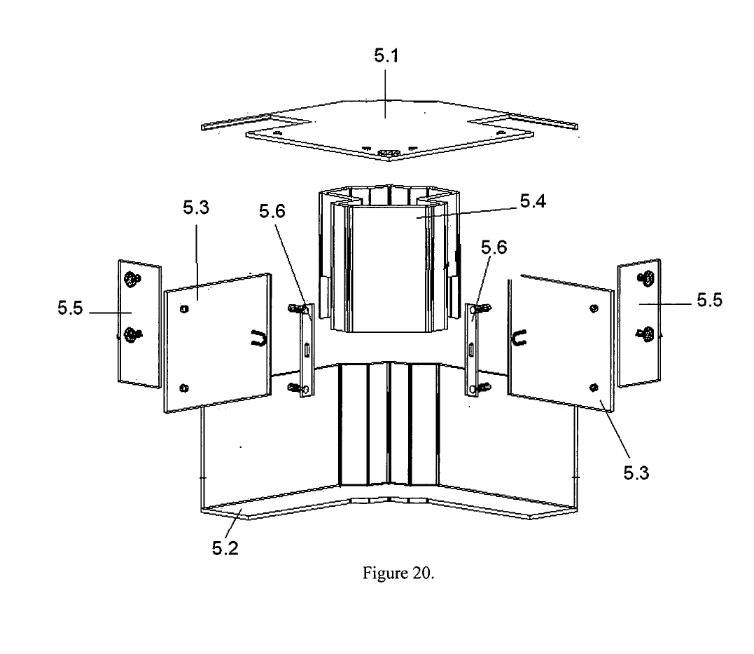

FIG. 20 illustrates a detailed view of the upper corner showing all its component parts.

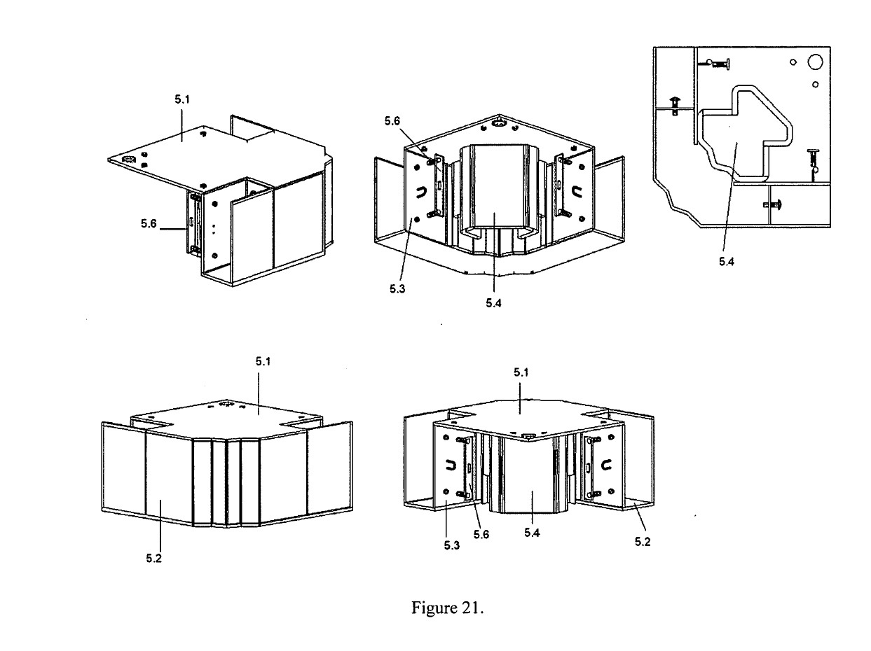

FIG. 21 shows a front view, a rear view, a right side view, a left side view and an upper view of the upper corner.

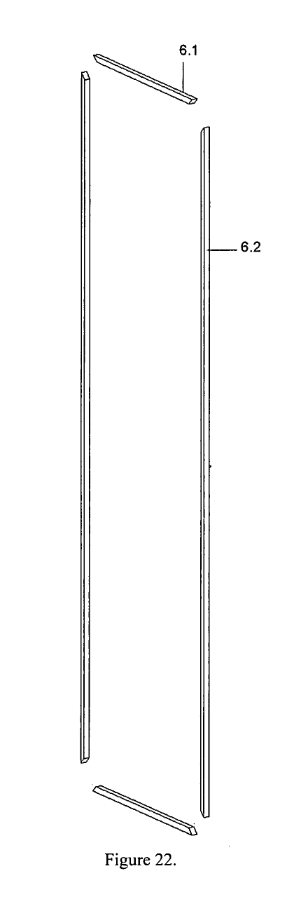

FIG. 22 is an elevation view of the support frame.

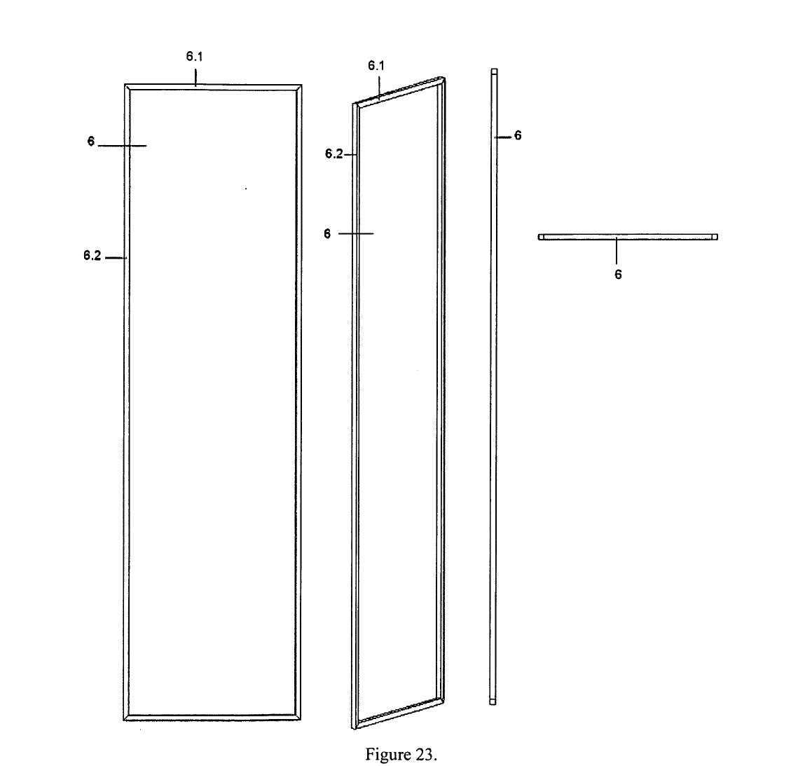

FIG. 23 shows a front view, a diagonal view, a side view and a upper view of the support frame.

Advertising support structures which are the objective of the present invention comprise six basic parts:

1—Profile Column (1).

2—Tank-like Lower Tubular Link Profile (2).

3—Upper Tubular Link (3).

4—Lower Base Corner (4).

5—Upper Corner (5).

6—Advertising Support Frames (6).

Column Profiles (1).

The column profiles (1) are formed by one single piece or a single body piece comprising polygonal-base prisms according to the model of the tower to be built.

These elements can be made of iron, plastic, fiberglass, aluminum, combinations thereof, or any other rigid or flexible material that supports it. The column profiles (1) can be coated with thermo-formed material with or without advertising. The column profiles (1) already completed, with its diverse angles, they acquire a physical aspect according to the polygonal bases that define their model, with aesthetic and ornamental details in relation to the polygonal bases, and giving greater resistance facilitating the activity of assembly and disassembly of the advertising device and providing harmony to the complete set of all parts.

The column profiles (1) play a dual role, firstly it provide support and security to the tower structure or advertising device that is built, because the conformation of its sides and the use of tongue and groove union systems or coupled to the lower corner base (4) and the upper corner (5) shape the structure of the tower or the advertising device, support the top of the tower and supports the advertising support frame (6), linking all these parties as a single body. Through its security holes pins offer adjustment in both lower (4) and upper (5) corner bases, allowing that the device may be moved as a single body. Similarly, the column profiles (1) have a decorative function as these profiles make the advertising device to be in harmony with the environment in which it is placed and being attractive to the eye, even without having advertisements placed.

The column profiles (1), which are the objective of the present invention, have various forms derived and conditioned by polygonal bases of the prism it forms. They are specially designed to get a tongue and groove joint or a perfect joint when coupled to lower corner base (4) and the upper corner (5) of the advertising device that would be assembled from such profiles and an aesthetically pleasing visual effect after being assembled.

Four of these forms can be seen in FIG. 9, without implying a limitation on the scope of the present invention, as it can get a new profile just by varying the polygonal bases of prisms that shape the column profiles (1) and other component parts that constitute the advertising support structures in the present invention.

By way of illustration and not limiting the scope of the present invention four embodiments of column profiles (1) are provided below, and are presented for illustrative purpose only without limiting the scope of the instant invention, which is supported by the figures that are an integral part of this specification.

### EXAMPLE NO. 1

A first form of the profile is a polygonal base prism having thirteen sides (7).

Where:

The biggest of their faces, the front section of the profile comprises six of its smaller sides (7a) (7b) (7c) (7d) (7e) and (7f), creating an uneven diamond-shape surface and where sides (7a) an d (7b) (7c) and (7d) (7e) and (7f) have the same length, being the joint of sides (7e) and (7f) the central joint of this face. The sides of the column profile (1) make up the sides (7g) (7h) (7i) (7j) (7k) and (7L), being (7g) and (7h) opposite sides of the same size; sides (7i) and (7j) are opposite sides of the same size; and sides (7k) and (7L) are also opposite sides of the same size. The back side of the thirteen sides polygon (7) forms the side (7m), with a straight side joined to the sides (7k) and (7L) to form the prism-shaped column profile of thirteen sided polygonal base (7).

The polygonal column profile of thirteen sides (7) has crossed reinforcements (11) and (12) extending through the entire length of the column profile (7), these crossed reinforcements connect the central part of side (7m) to the central union of the larger face formed by the convergence of sides (7e) and (7f) in its major portion and lower portion in the center connects the points of convergence of the sides (7g) and (7i) and sides (7h) and (7j), forming a union or crossed reinforcement throughout the thirteen-sided polygonal profile (7), giving it greater strength and resistance, as shown in FIGS. 9 and 10.

### EXAMPLE NO. 2

A second column profile is a polygonal base prism that has eight sides (8) or octagon.

Where:

The biggest of their faces, the front side, comprises solely the side (8a), which is parallel and opposite to the rear side which also comprises only one side, in this case the side (8h). The sides of this polygonal base prism (8) are made up of opposite sides (8b) and (8c) of equal length, and opposite sides (8d) and (8e) of equal length, and opposite sides (8f) and (8g) of equal length, matching the latter on the side (8h). Sides (8b) and (8c) match on the side (8a), forming an eight-sided polygonal base prism (8). The eight-sided polygonal column profile (8) has crossed reinforcements (13 and (14) extending through the entire length of the column profile (8), these reinforcements link the central part of side (8h) with the central union of main face on side (8a) on its larger portion; on the smaller portion reinforcements join the convergence points of sides (8b) and (8d), and sides (8c) and (8e), forming a union or crossed reinforcement throughout the eight-sided polygonal profile (8), giving it greater strength and consistency, as shown in FIGS. 9 and 11.

### EXAMPLE NO. 3

A third column profile is an eight-sided polygonal base prism (9) or octagon.

Where:

One side has a curved or arched shape (9a) and this is the larger side of the profile of column (9). The rear side is made up of the face (9h) and the lateral sides comprise faces (9b) and (9c) which are equal regarding size and parallel opposite sides; faces (9d) and (9e) are equal regarding size and parallel opposite sides; faces (9f) and (9g) are equal and parallel, forming all these sides an eight-sided polygonal base prism (9) where the longer side is a curved or arched side. The eight-sided polygonal column profile (9) has crossed reinforcements (15) and (16) extending through the entire length of the column profile (9), these reinforcements link the central part of side (9h) with the central union of main face on side (9a) on its larger portion; on the smaller portion reinforcements join the convergence points of sides (9c) and (9e), and sides (9b) and (9d), forming a union or crossed reinforcement throughout the eight-sided polygonal profile (9), giving it greater strength and consistency, as shown in FIGS. 9 and 12.

### EXAMPLE NO. 4

A fourth column profile is a polygonal base prism of nine sides (10) or enneagon

Where:

The rear face of the column profile is formed by the convergence of the sides (10a) and (10b). Also, the rear face of nine-sided polygonal base column profile (10) is formed by the side (10i) and sides (10h) and (10g), which are of equal opposite sides that are bound to side (10i); sides (10e) and (10h) are equal opposite sides; sides (10c) and (10d) are equal opposite sides which are connected to sides (10a) and (10b) to form a column profile constituted by a nine-sided polygonal base prism (10). The nine-sided polygonal column profile (10) has crossed reinforcements (17) and (18) extending through the entire length of the column profile (10). These reinforcements link the central part of side (10i) with central union of main face formed by the sides (10a) and (10b) on its larger portion; on the smaller portion, reinforcements join the convergence points of sides (10c) and (10e) and sides (10d) and (10f), forming a union or crossed reinforcement throughout the nine-sided polygonal profile (10), giving it greater strength and consistency, as shown in FIGS. 9 and 13.

Tank-Type Lower Tubular Link Profile (2).

Tank-type lower tubular link profiles (2) comprise six elements or parts, which are made and described according to tongue and groove assembly mode in combination with the key hole junction that binds it with a lower corner base (4). Thus, each part of the tank-type lower tubular link profile (2) form a tongue and groove polygonal joint, or could be attached to lower corner base (4), in combination with the high security key hole type slot, which has double latches for added protection and resistance.

The tank-type lower tubular link profile (2) can be made on iron, plastic, fiberglass, aluminum, combinations thereof, or any other rigid or flexible material that supports it. And also, it may be coated with thermo material formed with or without advertising. This device has the characteristic of being hollow and allows storing liquid or sand, among others materials in its inner cavity, that why it is said to be a tank-type profile.

The main function of the tank-type lower tubular link profile (2) is to be the basis of the advertising device, serving as a storage, reservoir or container which can be filled with water, sand or any other suitable material with the aim of securing the position and location of the advertising device without anchors or mechanisms to connect it to the ground. Thus, water or any other liquid in general or sand is used in this function and is introduced through the duct where screw (2.4) is located. Moreover, the tank-type lower tubular link profile (2) functions as a connection with the lower base corners (4), thus forming the base of the advertising device you want to assemble.

The tank-type lower tubular link profile (2) also comprises two blind covers or stamps (2.1) acting as hermetic seal of tank-type lower tubular link profile sides (2) to prevent leakage of the contents; and two covers slots (2.2), left and right, that allow the union with lower base corner (4) using key hole system, from the union of the latter to the sides of the tank-type lower tubular link profile (2) through the closing holes (2.6), combined with a tongue and groove or attached joint. This process ends with the placement of guardrail (2.5). The tank-type lower tubular link profile (2) also has the a thread sleeve (2.3) in which a screw cap (2.4) is placed and through which the material used to fill the internal cavity, such as water or sand is introduced in order to provide the advertising device with security and fixing without being anchored to the ground. All of which is shown in FIGS. 14 and 15.

Upper Tubular Link Profile (3).

It is composed of 2 (two) types of parts or elements, which are described in the mode of assembly and body support, forming a rectangular or polygonal body according to the model of the tower or advertising device that would be assembled.

These elements can be made of iron, plastic, fiberglass, aluminum, or the combinations thereof; or any other rigid or flexible material that supports it. This profile can be coated with thermo material formed with advertisement or not. The upper tubular profile link (3) is fixed to upper corner (5) to form the advertising device you want to assemble, using the high security key hole-type slot in combination with an attached or tongue and groove union and using double pins for added protection and resistance.

The upper tubular profile link (3) has an interior cavity and two slotted caps (3.1) are fixed in their faces in order to close the set and provide the dam or lock in the upper part of the advertising device by joining firmly to the upper corner (5) allowing greater security to all parts and pieces that make up the advertising device in general. All of which is shown in the FIGS. 16 and 17.

Lower Base Corner (4).

It is composed of eight (8) types of pieces, which are described according to the assembly and support modes. These elements can be made of iron, plastic, fiberglass, aluminum, combinations thereof, or any other rigid or flexible material that supports it. This corner can be coated with thermo material formed with advertisement or not.

Lower Base Corner (4) plays an essential role in the advertising device or advertising tower since it joins to the tank-type lower tubular link profiles (2) through the key hole binding system with dual latches for added protection and strength, combined with an attached or tongue and groove joint. This way it supports and fixes the column profiles (1) by a tongue and groove joint or attached to the support liner for column profile (4.1) of the base corner, connecting all these parts to form a single body.

Lower base corner (4) is formed by the support liner for columns profile (4.1) of the base corner, which is fixed to the column profile (1) by an attached or tongue and groove union; the upper side (4.2) covering the corner forms the lower base; the lower side (4.3) covers and forms the side lower base corner (4); the bottom cover (4.4) that forms the lower base corner platform; the right and left lateral pin (4.5) and (4.6) that allow the connection to the tank-type lower tubular link profile (2) through the key hole system; the safety latches (4.7) and pin padlocks (4.8) secure the bounding of the tank-type lower tubular link profile (2) to lower base corner (4). All of this being shown in FIGS. 18 and 19.

Upper Corner (5).

It is composed of 6 (six) types of parts, which are described according to the assembly and support mode. They form a body of rectangular or polygonal base in correspondence with the model of the tower or advertising device to be assembled. These elements can be made of iron, plastic, fiberglass, aluminum, combinations thereof, or any other rigid or flexible material that supports it. The upper corner (5) can be coated with thermo material formed with advertisement or not. Its main function is associated with fixing the upper tubular profiles links (3) by a joint using the key hole system with twin pins for greater protection and resistance, together with a tongue and groove or attached joint, and the bonding or fixing of columns profiles (1) through tongue and groove or attached joint to the support liner for column profile (5.4) of the upper corner, connecting all these parts as one body.

Upper corner base (5) comprises upper cover (5.1) which as its name suggests covers the top of the upper corner (5); side cover (5.2) of the upper corner (5) is part of the outer body and also covers the top of the column profile (1) once it is fixed to the upper corner (5) through the tongue and groove system; the side supports (5.3) that make up the channel connecting the upper tubular connection (3) to the upper corner (5); the support liner for column profile (1) of the top corner base (5.4), where the column profile (1) is attached to by a tongue and groove joint; inner covers with assembly rivet (5.5) to which upper tubular link (3) is joint by key hole joint system and the safety rails safe latches and grooves for lock and security seal (5.6), which contribute to joining and fastening the upper corner (5), as shown in FIGS. 20 and 21.

Advertising Display Support Frame (6).

It is composed of 2 (two) pieces, which are described according to assembly mode and body support, forming a geometric rectangular shape. Advertising message is fixed on the fence while the latter is connected to the advertising device on the quadrants resulting from the union of the component parts set out above. The advertising display support frame (6) can be manufactured in iron, plastic, fiberglass, aluminum, combinations thereof, or any other rigid or flexible material that supports it. This structure can be coated with thermo material formed with advertisement or not. The advertising display support frame (6) once assembled, takes a rectangular shape with harmonious details. It is composed of two upper links (6.1) and two lateral links (6.2) which join and take a rectangular shape on which the advertisement is placed before being posted on the tower or advertising device. All of which can be seen in FIGS. 22 and 23.

### EXEMPLIFICATION

The following examples are provided below in order to offer a better understanding of the provided below embodiments and for illustration purposes only, without limiting the scope of the present invention:

### Example No. 1

### Tower or Advertising Device in the Form of Flat Screen

This device comprises a front part with a supporting framework (6), where advertisements made of rigid, flexible materials, or combinations of both, may be installed on all sides of the device. It has lights that can be located inside or outside positions or combinations thereof, depending on the lighting requirements of the advertisement to be placed in the advertising tower and the characteristics of the place where you locate the advertising device.

The advertising tower in the form of flat screen comprises nine basic parts, as shown in FIGS. 1 and 2:

2 Columns Profiles (1).

1 Tank-type lower tubular link profile (2).

1 Upper tubular link (3).

2 Corner Bases (4).

2 Upper Corners (5)

1 Advertising Display Support Frame (6).

The visual impact of the advertising tower depends on the special features of columns profiles (1) used. That is, the desired visual impact will depend on the type of polygonal base prism conforming the column profile (1), and also on the type of joint (attached or tongue and groove) required in joining the corner base (4) to the upper corner (5).

Throughout the assembly process it will be observed and used joints through the key hole system in combination with tongue and groove joints or attached joints, just the way it has been explained above. Once the tower or advertising device is assembled, the tank-type lower tubular link profile (2) is filled with water in order to get stability and fixing to the floor.

Tower or advertising device in the form of flat screen may be different sizes or formats, but the recommended one is 21 feet high by 6 feet wide, including other space sizes, not limiting. An example of this tower or advertising device in the form of flat screen is shown in FIGS. 1 and 2.

### Example No. 2

### “V”-form Advertising Device or Tower

This device comprises two fronts with their support frames (6), and wherein advertisement may be placed on all faces using rigid and flexible materials, or combinations of both. It has lights that can be placed inside or outside positions or combinations thereof, depending on the lighting requirements of the advertisement to be shown in the advertising tower and the characteristics of the place where the advertising device is located.

“V”-shape Advertising Tower comprises 15 basic parts:

3 Columns Profiles (1).

2 Tank-type Lower Tubular Link Profiles (2).

2 Upper Tubular Links (3).

3 Corner Bases (4).

3 Upper Corners (5).

2 Advertising Display Support Frames. (6).

The visual impact of the advertising tower depends on the special features of columns profiles (1) used. That is, the visual impact to be obtained will depend on the type of polygonal base prism conforming the column profile (1), and also on the type of joint (attached or tongue and groove) used as required to join corner base (4) and upper corner (5).

In the assembling process joints through the key hole system in combination with tongue and groove joints or attached joints are used, as explained previously. Once the tower or advertising device is assembled, the tank-type lower tubular link profile (2) is filled with water in order to provide get stability to the device and proper fixing of it to the floor.

Flat-screen shaped tower or advertising devise may be have different sizes or formats. A preferably sizes has dimensions of 21 foot high by 6 foot wide, among other possible sizes. FIGS. 3 and 4 illustrate an example of said “V” shaped advertising tower.

### Example No. 3

### Tower or Advertising Device in the Form of a Triangular Base Prism

This device comprises three fronts with their respective support frames (6), to which advertisement may be installed on all sides using rigid or flexible materials, or combinations of both. It has lights that can be placed inside or outside positions or combinations thereof, depending on the lighting requirements of the advertisement to be shown in the advertising tower and the characteristics of the place wherein it is located or installed. The tower or advertising device in the form of triangular base prism is composed of 18 basic parts:

3 Columns Profiles (1)

3 Tank-type Lower Tubular Link Profiles (2).

3 Upper Tubular Links (3).

3 Corner Bases (4).

3 Upper Corners (5).

3 Advertising Display Support Frames (6).

The visual impact of the advertising tower depends on the special features of columns profiles (1) used. That is, the desired visual impact will depend on the type of polygonal base prism conforming the column profile (1), and also on the type of joint (attached or tongue and groove) selected and used to join corner base (4) to upper corner (5).

In the assembling process, joints through the key hole system in combination with tongue and groove joints or attached joints, are used as previously explained. Once the tower or advertising device is assembled, the tank-type lower tubular link profile (2) is filled with water in order to add stability and proper fixing of the device to the floor. Triangular shaped tower or advertising devise may be have different sizes or formats. A preferably sizes has dimensions of 21 foot high by 6 foot wide, among other possible sizes. FIGS. 5 and 6 illustrate an example of said triangular shaped Advertising Tower.

### Example No. 4

### Tower or Advertising Device in the Form of a Vertical Rectangular Base Cube

This device comprises four fronts with their support frames (6), to which advertisement may be installed on all sides using rigid or flexible materials, or combinations of both. It has lights that can be placed inside or outside positions or combinations thereof, depending on the lighting requirements of the advertisement to be shown in the advertising tower and the characteristics of the place where you locate the advertising device. The tower or advertising device in the form of vertical rectangular base cube comprises 24 easy-to-assemble basic parts:

4 Columns Profiles (1).

4 Tank-type Lower Tubular Link Profiles (2).

4 Upper Tubular Links (3).

4 Corner Bases (4).

4 Upper Corners (5).

4 Advertising Display Support Frames (6).

The visual impact of the advertising tower depends on the special features of columns profiles (1) used. That is, the desired visual impact will depend on the type of polygonal base prism conforming the column profile (1), and also on the type of joint (attached or tongue and groove) used to join corner base (4) to upper corner (5).

Throughout the assembling process joints through the key hole system in combination with tongue and groove joints or attached joints, are used as previously explained above. Once the tower or advertising device is assembled, the tank-type lower tubular link profile (2) is filled with water in order to get stability and fixing to the floor. This advertising tower in the form of triangular based prism can be different sizes or formats but the recommended pattern is 21 feet high by 6 feet wide, each face; and space sizes are not limitative.

An example of this tower or advertising device in the form of a vertical rectangular base cube is shown in FIGS. 7 and 8.

1. Advertising display devices and constituent structures characterized by having at least two columns profiles (1), at least one tank-type lower tubular link profiles (2), at least one upper tubular link (3), at least two corner bases (4), at least two upper corners (5), and at least one advertising display support frame (6).

2. Advertising display devices and constituent structures according to claim 1 wherein the columns profiles are composed by polygonal base prisms.

3. Advertising display devices and constituent structures according to claims 1 and 2 characterized by the columns profiles have at least two inner crossed reinforcements which extend all along the length of the column profile (1).

4. Advertising display devices and constituent structures according to claim 1 characterized because the tank-type lower tubular link profile (2) has a blank cover or seal (2.1), two covers slots (2.2) closing holes (2.6), safety rails (2.5), at least one threaded liner (2.3), and at least one threaded stopper (2.4).

5. Advertising display devices and constituent structures according to claims 1 and 2 and characterized because tank-type lower tubular link profile (2) is joined to the base corner (4) through a key hole type slots system, with double pins in combination with tongue and groove or attached joint.

6. Advertising display devices and constituent structures that shape it according to claims 1 and 4 wherein tank-type lower tubular link profile (2) is filled with liquid or sand for floor fixing.

7. Advertising display devices and constituent structures according to claim 1 wherein the upper tubular link (3) comprises a tubular body with faces, or rectangular or polygonal bases where two slotted covers are set (3.1) and at the same time they are suitable for closing the upper tubular link (3) and the joint with the upper corner (5) by means of a key hole type joint with double pins in combination with an attached or tongue and groove joint.

8. Advertising display devices and constituent structures according to claim 1 characterized because the base corner (4) is formed by the support liner for columns profile (4.1) of the base corner; the upper side (4.2); the lower side (4:3); the bottom cover (4.4); the right side with pins (4.5) and the left side with pins (4.6), safety pins (4.7) and pin locks (4.8).

9. Advertising display devices and constituent structures according to claims 1 and 7 wherein the column profile (1) is attached to the support liner for columns profile (4.1) of the base corner by means of an attached or tongue and groove joint.

10. Advertising display devices and constituent structures according to claims 1 and 7 wherein the upper side (4.2) covers the middle upper part of the lower corner base (4).

11. Advertising display devices and constituent structures according to claims 1 and 7 wherein the lower side (4.3) covers the middle lower part of the lower corner base (4).

12. Advertising display devices and constituent structures according to claims 1 and 7 wherein the bottom cover (4.4) provides platform for the lower corner base.

13. Advertising display devices and constituent structures to claim 1 wherein the upper corner (5) comprises the upper cover (5.1); the lateral (5.2); the side supports (5.3); the support liner for column profile (5.4) the upper corner; the inner covers with assembly rivets (5.5) and the security seal (5.6).

14. Structural profiles and advertising devices containing them according to claims 1 and 13 wherein the top cover (5.1) covers the upper part of the upper corner (5).

15. Advertising display devices and constituent structures according to claims 1 and 13 wherein the lateral (5.2) forms the upper side of the corner base (5) and covers the top of the column profile (1) once it joins the upper corner (5).

16. Advertising display devices and constituent structures according to claims 1 and 13 wherein the side supports (5.3) make up the channel of bonding upper tubular link (3) with the upper corner base (5).

17. Advertising display devices and constituent structures according to claims 1 and 13 wherein the upper corner base (5) and the upper tubular link (3) are joined by a key hole slots-type system, with double pins in combination with attached or tongue and groove joint.

18. Advertising displays devices and structures according to claims 1 and 13 wherein the support liner for column profile (5.4) of the upper corner base joins through an attached or tongue and groove joint with the column profile (1).

19. Advertising display devices and constituent structures according to claims 1 and 13 wherein the inner covers with assemble rivets (5.5) binds through a key hole type joint; the upper tubular link (3) and rails with safety pins and grooves for lock and security seal (5.6).

20. Advertising display devices and constituent structures according to claim 1 wherein the advertising display support frame (6) is composed of two upper links (6.1) and two lateral links (6.2); when they meet, they get a rectangular form where the advertisement is placed.
